(19) United States
(12) Patent Application Publication
(10) Pub. No.: US 2014/0089582 A1
(43) Pub. Date: Mar. 27, 2014

(54) DISK ARRAY APPARATUS, DISK ARRAY CONTROLLER, AND METHOD FOR COPYING DATA BETWEEN PHYSICAL BLOCKS

(71) Applicants: KABUSHIKI KAISHA TOSHIBA, Tokyo (JP); TOSHIBA SOLUTIONS CORPORATION, Tokyo (JP)

(72) Inventor: Masaki KOBAYASHI, Tokyo (JP)

(73) Assignees: TOSHIBA SOLUTIONS CORPORATION, Tokyo (JP); KABUSHIKI KAISHA TOSHIBA, Tokyo (JP)

(21) Appl. No.: 13/838,056

(22) Filed: Mar. 15, 2013

Related U.S. Application Data
(63) Continuation of application No. PCT/JP2012/074190, filed on Sep. 21, 2012.

(51) Int. Cl. G06F 3/06

(52) U.S. Cl. CPC G06F 3/0689; G06F 3/0614; G06F 3/065
USPC 711/114

(57) ABSTRACT

According to one embodiment, a disk array controller includes a data copy unit and a physical block replacement unit. The data copy unit copies data from a master logical disk to a backup logical disk in order to set the master logical disk and the backup logical disk in a synchronization status. The physical block replacement unit allocates a third physical block to the backup logical disk, before data is copied from a first physical block allocated to the master logical disk to the backup logical disk, when the allocation is changed to the third physical block instead of a second physical block that is associated with the first physical block and is allocated to the backup logical disk.

### CROSS REFERENCE TO RELATED APPLICATIONS

This application is a Continuation Application of PCT Application No. PCT/JP2012/074190, filed Sep. 21, 2012, the entire contents of which are incorporated herein by reference.

### FIELD

Embodiments described herein relate generally to a disk array apparatus, a disk array controller, and a method for copying data between physical blocks.

### BACKGROUND

Generally, a disk array device includes a plurality of physical disks such as hard disk drives (HDD) or solid state drives (SSD). The disk array device includes one or more disk arrays each defined as one area in which storage areas of the plurality of physical disks are continuous. A controller of the disk array device (that is, a disk array controller) defines (constructs) one or more logical disks (for example, a plurality of logical disks) using the storage areas of one or more disk arrays described above.

In addition, recently, disk array devices using a pair of arbitrary logical disks as a master logical disk and a backup logical disk for improving the reliability are known. In such disk array devices, replication and data movement (hereinafter, referred to as migration) are performed.

The replication represents an operation of copying data from a master logical disk to a backup logical disk. After the copying of data is completed, the master logical disk and the backup logical disk shift to a synchronization status. In the synchronization status, data written to the master logical disk is written to the backup logical disk as well.

When the master logical disk and the backup logical disk are logically separated from each other, both disks shift to a split status. In a case where data is updated in either the master logical disk or the backup logical disk (that is, data is written to a single disk) in the split status, the disk array controller manages a data update range (write range) thereof as a difference. More specifically, the disk array controller manages the data update range as a difference area based on difference information. In order to shift the master logical disk and the backup logical disk to the synchronization status again, the disk array controller copies data from the master logical disk to the backup logical disk only for an area (that is, a difference area) in which data does not coincide in both disks based on the difference information. The copying of data is referred to as replication copying or difference copying.

The migration represents an operation of replacing a first physical block allocated to a logical block of the logical disk with a second physical block other than the first physical block. In the migration, data is copied from the first physical block (that is, a physical block as a replacement source) to the second physical block (that is, a physical block as a replacement destination). The copying of data is referred to as migration copying.

The disk array controller writes data to be written to the logical block during the migration copying to both the first and second physical blocks. After the migration copying is completed, the disk array controller replaces the first physical block allocated to the logical block with the second physical block. That is, the disk array controller replaces mapping information that represents the correspondence between logical blocks and physical blocks.

For determining a physical block that is a migration target, conventionally, various methods have been proposed. The simplest method involves a low-speed physical block being replaced with a high-speed physical block in a case where the load of the low-speed physical block is high. In contrast to this, a method may be also applied in which a high-speed physical block is replaced with a low-speed physical block in a case where the load of the high-speed physical block is low.

In a conventional technology, two types of copy operations described above are independently performed. However, a copy operation performed by the disk array controller affects the performance of a reply to an access request (data access request) issued from a host device to the disk array controller.

### BRIEF DESCRIPTION OF THE DRAWINGS

FIG. 1 is a block diagram showing an exemplary hardware configuration of a storage system according to an embodiment;

FIG. 2 is a block diagram mainly showing the functional configuration of a disk array controller shown in FIG. 1;

FIG. 3 is a diagram illustrating physical blocks of a RAID group;

FIG. 4 is a diagram illustrating RAID groups included in a storage pool;

FIG. 5 is a diagram illustrating the definition of a logical disk;

FIG. 6 is a diagram showing an example of the data structure of physical block management data;

FIG. 7 is a diagram showing an example of the data structure of logical block management data;

FIG. 8 is a diagram showing an example of the data structure of storage pool management data;

FIG. 9 is a diagram showing an example of the data structure of a logical-physical mapping table;

FIG. 10 is a diagram illustrating data copy from a master logical disk to a backup logical disk;

FIG. 11 is a diagram illustrating replication status transitions;

FIG. 12 is a diagram showing an example of the hierarchical organization of physical areas of a RAID group;

FIG. 13 is a diagram showing an example of the allocation of physical blocks of different tiers to logical blocks of a logical disk;

FIGS. 14A and 14B are diagrams illustrating an overview of the process of replacing a physical block allocated to a logical block of the logical disk;

FIG. 15 is a flowchart showing an exemplary procedure for a read process applied to the embodiment; and

FIG. 16 is a flowchart showing an exemplary procedure for a replication copy process applied to the embodiment.

### DETAILED DESCRIPTION

Various embodiments will be described hereinafter with reference to the accompanying drawings.

In general, according to one embodiment, a disk array apparatus comprises a plurality of disk arrays and a disk array controller. The disk array controller is configured to control the plurality of disk arrays. The disk array controller comprises a logical block management unit, a data copy unit, and a physical block replacement unit. The logical block management unit is configured to define a plurality of logical disks by allocating a plurality of physical blocks selected from the plurality of disk arrays to the plurality of logical disks. The data copy unit is configured to copy data from a master logical disk to a backup logical disk in order to set the master logical disk and the backup logical disk in a synchronization status. The physical block replacement unit is configured to allocate a third physical block to the backup logical disk instead of a second physical block that is associated with a first physical block allocated to the master logical disk and is allocated to the backup logical disk, before data is copied from the first physical block to the backup logical disk, when the allocation is changed to the third physical block instead of the second physical block.

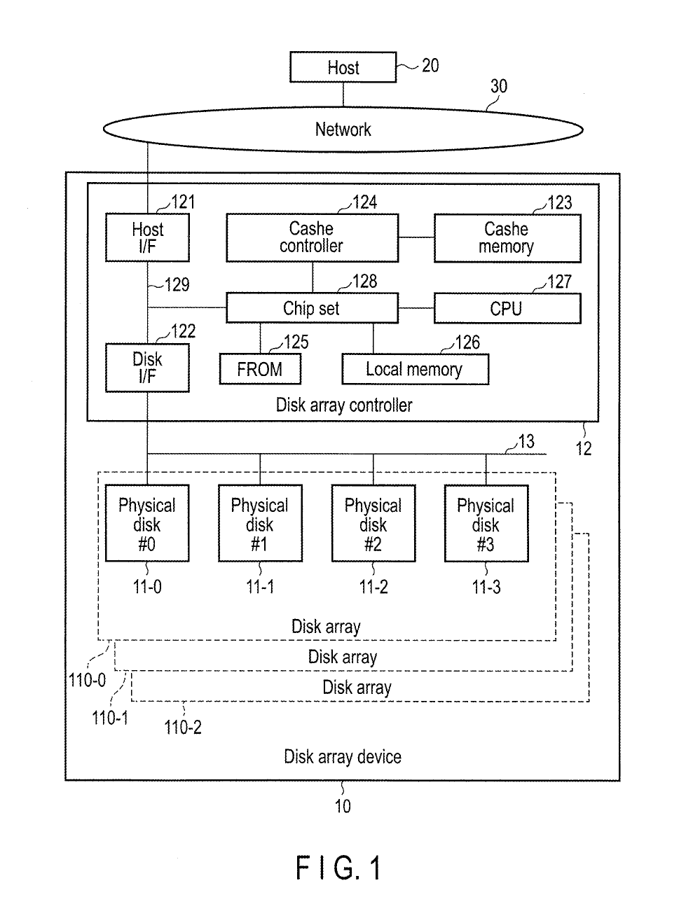

FIG. 1 is a block diagram showing an exemplary hardware configuration of a storage system according to an embodiment. The storage system comprises a disk array device 10, a host computer (hereinafter, referred to as a host) 20, and a network 30. The disk array device 10 is connected to the host 20 via the network 30. The host 20 uses the disk array device 10 as an external storage device. The network 30, for example, is a storage area network (SAN), the Internet, or an intranet. The Internet or the intranet, for example, is configured using Ethernet (registered trademark).

The disk array device 10, for example, includes a physical disk group including physical disks 11-0 to 11-3, a disk array controller 12, and a disk interface bus 13. The physical disk group is a solid state drive (SSD) group, a hard disk drive (HDD) group, or an SSD group and a HDD group. In the embodiment, the physical disk group is assumed to be the SSD group and the HDD group. Each SSD of the SSD group comprises a set of rewritable non-volatile memories (for example, flash memories).

The disk array controller 12 is connected to the physical disk group including the physical disks 11-0 to 11-3 via the disk interface bus 13. The interface type of the disk interface bus 13, for example, is a small computer system interface (SCSI), a fibre channel (FC), a serial attached SCSI (SAS), or a serial AT attachment (SATA).

The disk array controller 12 controls the physical disk group. The disk array controller 12 constructs disk arrays using a plurality of physical disks and manages the disk arrays. In the example shown in FIG. 1, three disk arrays 110-0 to 110-2 are illustrated. The disk arrays 110-0 to 110-2 are arrays having a RAID configuration (that is, RAID disk arrays) constructed, for example, using RAID (redundant arrays of independent disks or redundant arrays of inexpensive disks) technology. Each of the disk arrays 110-0 to 110-2 is managed as a single physical disk by the disk array controller 12 (disk array control program). In the description presented below, when the disk arrays 110-0 to 110-2 do not need to be particularly discriminated from one another, each of the disk arrays 110-0 to 110-2 will be denoted by 110-*. Similarly, when the physical disks 11-0 to 11-3 do not need to be particularly discriminated from one another, each of the physical disks 11-0 to 11-3 will be denoted by 11-*.

The disk array controller 12 includes a host interface (host I/F) 121, a disk interface (disk I/F) 122, a cache memory 123, a cache controller 124, a flash ROM (FROM) 125, a local memory 126, a CPU 127, a chipset 128, and an internal bus 129. The disk array controller 12 is connected to the host 20 using the host I/F 121 via the network 30. The interface type of the host I/F 121, for example, is an FC or an Internet SCSI (iSCSI).

The host I/F 121 controls data transmission (data transmission protocol) to or from the host 20. The host I/F 121 receives a data access request (a read request or a write request) for a logical disk (logical volume), which is issued by the host 20, and replies in response to the data access request. The logical disk is logically implemented using at least a part of the storage area of one or more disk arrays 110-* as an actual body. When the data access request is received from the host 20, the host I/F 121 transfers the request to the CPU 127 via the internal bus 129 and the chipset 128. The CPU 127 that has received the data access request processes the data access request based on a disk array control program.

When the data access request is a write request, the CPU 127 specifies a physical area of the disk array 110-* that is allocated to an access area (a logical area of the logical disk) designated by the write request and controls data writing. More specifically, the CPU 127 controls first data writing or second data writing. The first data writing is an operation of storing write data in the cache memory 123 once and then writing the data to the specified physical area of the disk array 110-*. The second data writing is an operation of directly writing write data to the specified physical area. In the embodiment, it is assumed that the first data writing is performed.

On the other hand, when the data access request is a read request, the CPU 127 specifies a physical area of the disk array 110-* that is allocated to an access area (a logical area of the logical disk) designated by the read request and controls data reading. More specifically, the CPU 127 controls first data reading or second data reading. The first data reading is performed in a case where data of the specified physical area is stored in the cache memory 123. That is, the first data reading is an operation of reading the data of the specified physical area from the cache memory 123 and replying with the read data to the host I/F 121, in order to cause the host I/F 121 to reply with the read data to the host 20. The second data reading is performed in a case where data of the specified physical area is not stored in the cache memory 123. That is, the second data reading is an operation of reading the data from the specified physical area of the disk array 110-* and replying with the read data to the host I/F 121, in order to cause the host I/F 121 to reply with the read data to the host 20. The data read from the specified physical area is stored in the cache memory 123.

The disk I/F 122 transmits a write request or a read request for a physical disk 11-* of the disk array 110-* in accordance with a data access request (a write request or a read request for a logical disk) from the host 20, which has been received by the CPU 127 (disk array control program), and receives a reply thereto. When a data access request from the host 20 is received by the host I/F 121, the cache memory 123 is used as a buffer for speeding up a reply of the completion to the data access request (a write request or a read request).

When the data access request is a write request, the CPU 127 avoids an access to the disk array 110-* that requires a time for a write process. Accordingly, the CPU 127 completes the write process by storing write data in the cache memory 123 once using the cache controller 124 and replies with a response to the host 20. Thereafter, the CPU 127 writes the write data to the physical disk 11-* of the disk array 110-* at an arbitrary timing. Then, the CPU 127 frees, using the cache controller 124, the storage area of the cache memory 123 in which the write data is stored.

On the other hand, when the data access request is a read request, in a case where requested data (that is, data to be read) is stored in the cache memory 123, the CPU 127 avoids an access to the disk array 110-* that requires a time for a read process. Accordingly, the CPU 127 obtains, using the cache controller 124, the requested data from the cache memory 123 and replies with a response to the host 20 (first data reading).

The cache controller 124 reads data from the cache memory 123 in accordance with a command supplied from the CPU 127 (disk array control program). In addition, the cache controller 124 writes data to the cache memory 123 in accordance with a command supplied from the CPU 127. Here, in order to allow the cache controller 124 to respond to the read request preferably using data stored in the cache memory, data may be read from the physical disk 11-* in advance. That is, the cache controller 124 may predict a read request having a possibility of being generated in the future, read corresponding data from the physical disk 11-* in advance, and store the read data in the cache memory 123.

The FROM 125 is a rewritable non-volatile memory. The FROM 125 is used for storing a disk array control program that is executed by the CPU 127. As a first process performed when the disk array controller 12 is started up, the CPU 127 copies the disk array control program stored in the FROM 125 to the local memory 126. Here, a non-volatile memory dedicated for reading data, for example, a ROM may be used instead of the FROM 125.

The local memory 126 is a volatile memory in which data can be rewritten, such as a DRAM. A part of the storage area of the local memory 126 is used for storing the disk array control program copied from the FROM 125. On the other hand, the other part of the storage area of the local memory 126 is used as a work area for the CPU 127. The CPU 127 controls the entire disk array device 10 (especially, each unit of the disk array controller 12) in accordance with program codes of the disk array control program stored in the local memory 126. That is, the CPU 127 reads the disk array control program stored in the local memory 126 via the chipset 128 and executes the read disk array control program, thereby controlling the entire disk array device 10.

The chipset 128 is a bridge circuit that connects the CPU 127 and peripheral circuits thereof to the internal bus 129. The internal bus 129 is a universal bus and, for example, is a peripheral component interconnect (PCI) express bus. The host I/F 121, the disk I/F 122, and the chipset 128 are interconnected via the internal bus 129. In addition, the cache controller 124, the FROM 125, the local memory 126, and the CPU 127 are connected to the internal bus 129 via the chipset 128.

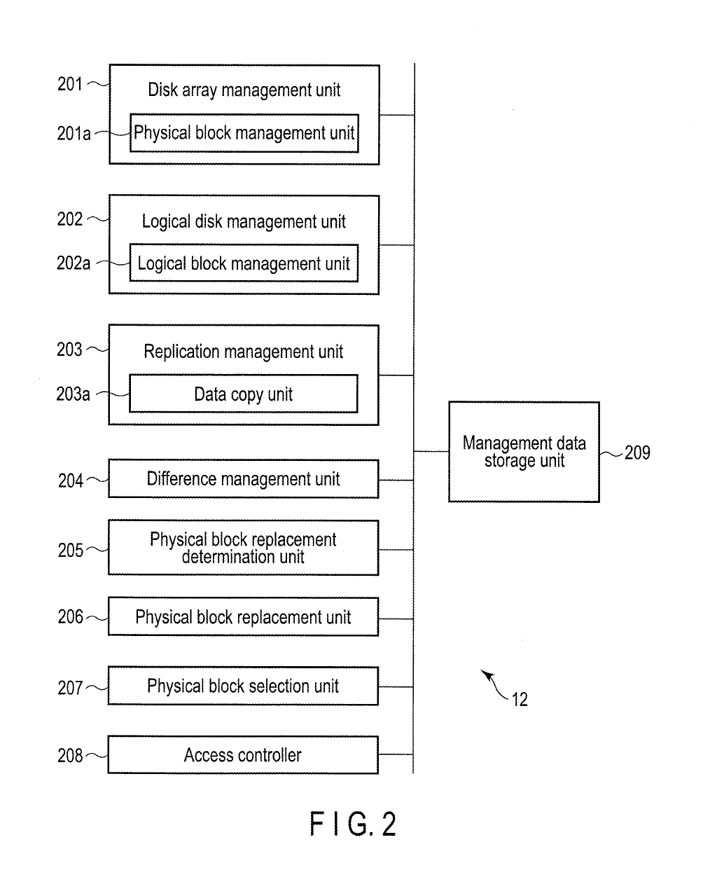

FIG. 2 is a block diagram that mainly illustrates the functional configuration of the disk array controller 12 shown in FIG. 1. The disk array controller 12 includes a disk array management unit 201, a logical disk management unit 202, a replication management unit 203, a difference management unit 204, a physical block replacement determination unit 205, a physical block replacement unit 206, a physical block selection unit 207, and an access controller 208. The functions of the functional elements 201 to 208 will be described later. The disk array management unit 201, the logical disk management unit 202, and the replication management unit 203 include a physical block management unit 201a, a logical block management unit 202a, and a data copy unit 203a, respectively. In addition, the disk array controller 12 further includes a management data storage unit 209 for storing various kinds of management data (management data list). The management data will be described later. The management data storage unit 209, for example, is implemented using a part of the storage area of the local memory 126 shown in FIG. 1.

In the embodiment, the above-described functional elements 201 to 208 are software modules that are implemented by the CPU 127 of the disk array controller 12 shown in FIG. 1 executing the disk array control program. However, some or all of the functional elements 201 to 208 may be implemented by hardware modules.

Next, the relation between the disk array and the logical disk applied in the embodiment will be described. In disk array devices of the initial period, generally, the storage area of a single disk array is allocated to a logical disk. That is, a logical disk is defined using a single disk array.

In contrast to this, in recent disk array devices, a plurality of disk arrays or a single disk array is grouped in units of storage pools SP. That is, a plurality of disk arrays or a single disk array is managed in units of storage pools SP. A disk array (RAID disk array) within the storage pool SP is referred to as a RAID group. A logical disk is defined (constructed) using a set of physical resources (physical blocks) meeting a necessary capacity, which are selected from one or more disk arrays (RAID groups) within the storage pool SP and is supplied to the host 20. Also in the embodiment, a logical disk is defined using such a method. In the embodiment, a plurality of disk arrays are assumed to be grouped into a storage pool SP.

The disk array management unit 201 of the disk array controller 12 defines a disk array (RAID group) using a plurality of physical disks. In addition, the disk array management unit 201 divides the storage area of each disk array (RAID group) into units of physical blocks of a constant capacity (size). From this, the disk array management unit 201 manages disk arrays as the aggregation of physical blocks. The physical block management unit 201a of the disk array management unit 201 manages each physical block of the disk array based on physical block management data PBMD to be described later. The physical block may be referred to as a physical segment or a physical extent.

The logical disk management unit 202 of the disk array controller 12 calculates the number of physical blocks required for meeting a target capacity of the logical disk. The logical disk management unit 202 equally selects physical blocks, for example, the number of which is necessary from the disk arrays (RAID groups) included in the storage pool SP and associates the selected physical blocks with a logical disk (more specifically, logical blocks of the logical disk).

From this, the logical disk management unit 202 defines and manages logical disks. That is, the logical disk management unit 202 defines and manages a logical disk as the logical aggregation of a plurality of physical blocks.

The logical block management unit 202a of the logical disk management unit 202 manages each logical block of the logical disk based on logical block management data LBMD. The logical block management data LBMD, as will be described later, includes a physical block pointer (that is, mapping information) representing a physical block associated with (allocated to) a logical block represented by the management data LBMD.

When an access to the logical disk defined by the logical disk management unit 202 is requested, the access controller 208 determines a disk array and a physical block to which a logical area of the requested access range corresponds. The access controller 208 accesses the specified physical block.

According to the method of defining a logical disk applied to the embodiment, a logical disk of an arbitrary capacity can be defined without being dependent on the capacity of each disk array. In addition, according to the above-described method of defining a logical disk, an access to one logical disk can be distributed to physical blocks of a plurality of disk arrays. From this, the concentration of accesses to part of the disk arrays is prevented, and a response to a data access request from the host 20 can be speedy.

In addition, according to the above-described method of defining a logical disk, each of a plurality of disk arrays is constructed by physical disks (drives) having access performance levels different from each other, whereby a logical disk can be defined using physical blocks having access speeds different from each other. In such a case, by allocating a physical block having a performance level optimal to a logical block based on the load of the logical block, the performance can be optimized. The allocation of a physical block to a logical block can be dynamically changed. For example, in order to replace a first physical block allocated to the logical block with a second physical block, data stored in the first physical block needs to be moved (copied) to the second physical block. The operation of changing a physical block allocated to a logical block is called migration. In addition, in the above-described method of defining a logical disk, by allocating a physical block when a write request is received from the host device, a logical disk of a size larger than the actual physical size can be constructed. This is called thin provisioning.

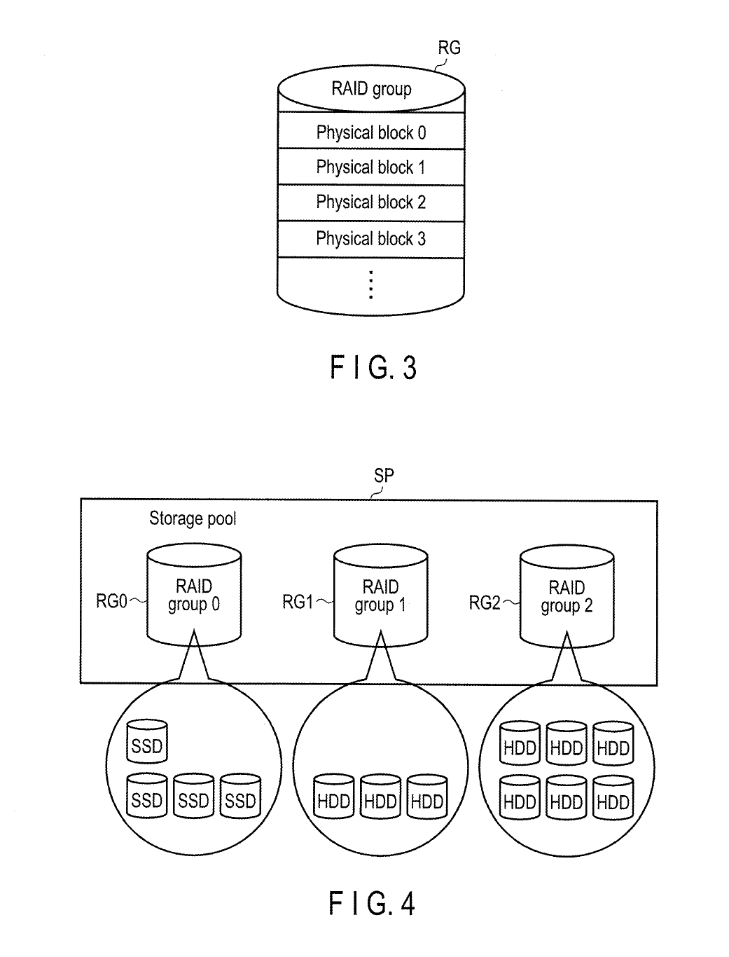

FIG. 3 is a diagram illustrating physical blocks of a RAID group (disk array) RG. The RAID group RG is defined (constructed), using a plurality of physical disks, by the disk array management unit 201. When the RAID group RG is defined, the storage area (physical area) of the RAID group RG, for example, is divided into units of physical blocks having a constant capacity (size) from the start of the storage area by the physical block management unit 201a of the disk array management unit 201.

Accordingly, the RAID group RG substantially includes a storage area comprising a plurality of physical blocks 0, 1, 2, 3 . . . . A physical block i (i=0, 1, 2, 3 . . . ) is a physical block having a physical block number of i. That is, consecutive physical block numbers are allocated to all the physical blocks of the RAID group RG in order from the leading physical block. The capacities of the physical blocks may be fixed or may be designated by a user using parameters.

FIG. 4 is a diagram illustrating RAID groups included in the storage pool SP. In the example shown in FIG. 4, three disk arrays (RAID disk arrays) are grouped (defined) as RAID groups 0 (RG0) to 2 (RG2) that are elements of the storage pool SP by the disk array management unit 201. That is, the storage pool SP is defined as a set of RAID groups 0 (RG0) to 2 (RG2).

FIG. 4 shows that RAID group 0 (RG0) is a disk array comprising four solid state drives (SSDs). The SSDs, for example, are SAS-SSDs to which SAS interfaces are applied. In addition, FIG. 4 shows that RAID group 1 (RG1) is a disk array comprising three hard disk drives (HDDs), and RAID group 2 (RG2) is a disk array comprising six HDDs. The HDDs, for example, are SAS-HDDs to which SAS interfaces are applied.

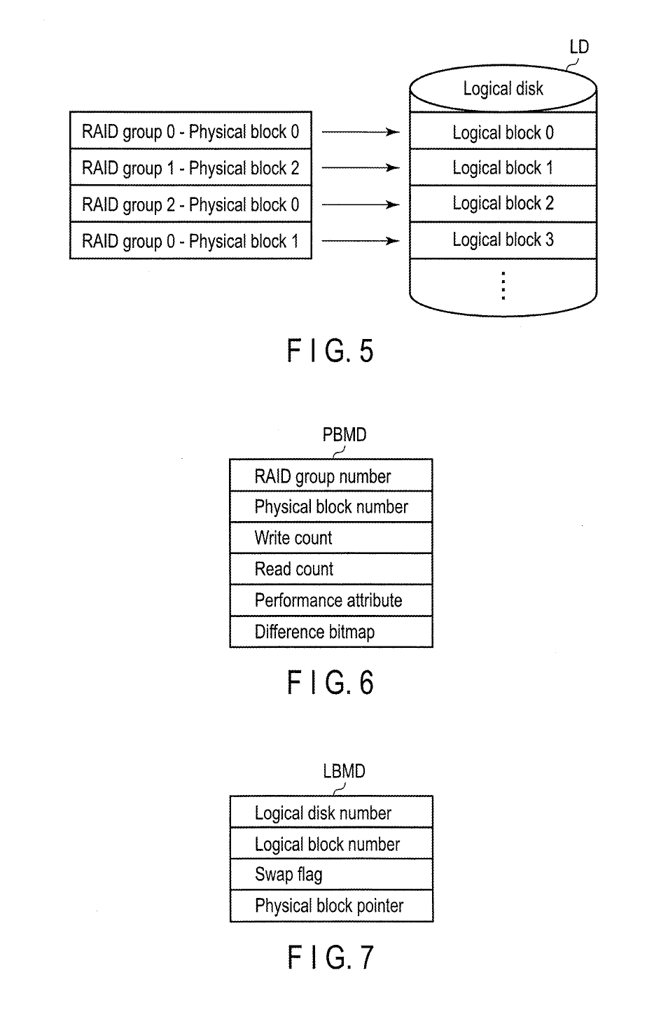

FIG. 5 is a diagram illustrating the definition of a logical disk. As shown in FIG. 5, the storage area (logical area) of a logical disk LD, for example, is divided into units of logical blocks having a constant capacity (size) from the start of the storage area by the logical block management unit 202a of the logical disk management unit 202. The capacity of this logical block is the same as that of the physical block. The logical disk LD substantially includes a storage area comprising a plurality of logical blocks 0, 1, 2, 3, . . . . A logical block i (i=0, 1, 2, 3, . . . ) is a logical block having a logical block number of i. That is, consecutive logical block numbers are allocated to all the logical blocks of the logical disk LD in order from the leading logical block.

To the logical blocks 0, 1, 2, 3, of the logical disk LD, physical blocks, for example, selected from RAID groups RG0(0) to RG2(2) included in the storage pool SP shown in FIG. 4 are allocated by the logical disk management unit 202. That is, the logical disk LD is defined as a set of physical blocks selected from RAID groups 0 to 2 by the logical disk management unit 202. In the example shown in FIG. 5, physical block 0 of RAID group 0 and physical block 2 of RAID group 1 are allocated to logical blocks 0 and 1 of the logical disk LD. In addition, physical block 0 of RAID group 2 and physical block 1 of RAID group 0 are allocated to logical blocks 2 and 3 of the logical disk LD.

Next, various types of management data applied to the embodiment will be described. In a case where the RAID group (disk array) RG is defined by the disk array management unit 201, the physical block management unit 201a generates physical block management data PBMD for each physical block of the RAID group RG. The physical block management data PBMD is used for managing the physical block and is stored in the management data storage unit 209.

FIG. 6 shows an example of the data structure of the physical block management data PBMD. As shown in FIG. 6, the physical block management data PBMD comprises a RAID group number, a physical block number, a write count, a read count, a performance attribute, and a difference bitmap.

The RAID group number is a number that is allocated to a RAID group RG having a physical block (hereinafter, referred to as a corresponding physical block) managed based on the physical block management data PBMD. The physical block number is a number that uniquely determines the corresponding physical block. The write count is a statistical value representing the number of times (write access frequency) of writing data to the corresponding physical block, and the read count is a statistical value representing the number of times (read access frequency) of reading data from the corresponding physical block.

The performance attribute represents an access performance of a physical disk having the corresponding physical block, for example, determined based on the type. In the embodiment, the performance attribute represents higher performance as the attribute value thereof is smaller. The attribute value of the performance attribute according to the embodiment, as will be described, is 0, 1, or 2. In a case where the corresponding physical block is allocated to a logical block of the master logical disk or the backup logical disk, the difference bit map is used for recording a difference between data of the corresponding physical block and data of a physical block as a copy destination or a copy source. Generally, each physical block comprises a set of sectors that are minimal units of access. Thus, the difference bitmap comprises a set of bits each representing whether there is a difference for each sector of the corresponding physical block. In the embodiment, in a case where each bit of the difference bitmap is “1”, it represents that there is a difference between sectors corresponding to each other.

In a case where the logical disk LD is defined by the logical disk management unit 202, the logical block management unit 202a generates logical block management data LBMD for each logical block of the logical disk LD. The logical block management data LBMD is used for the managing logical block and is stored in the management data storage unit 209.

FIG. 7 shows an example of the data structure of the logical block management data LBMD. As shown in FIG. 7, the logical block management data LBMD comprises a logical disk number, a logical block number, a swap flag, and a physical block pointer.

The logical disk number is a number that is allocated to the logical disk LD having a logical block (hereinafter, referred to as a corresponding logical block) managed based on the logical block management data LBMD. The logical block number is a number that uniquely determines the corresponding logical block. In a case where the logical disk having the corresponding logical block is one of the master logical disk and the backup logical disk, the swap flag represents whether the physical block allocated to the corresponding logical block is to be replaced with the physical block allocated to the logical block of the other of the master logical disk and the backup logical disk. The physical block pointer is mapping information indicating the physical block management data PBMD used for managing the physical block allocated to the corresponding logical block.

In a case where the storage pool is defined as a set of a plurality of disk arrays (RAID groups), the disk array management unit 201 generates storage pool management data SPMD used for managing the storage pool. The storage pool management data SPMD is stored in the management data storage unit 209.

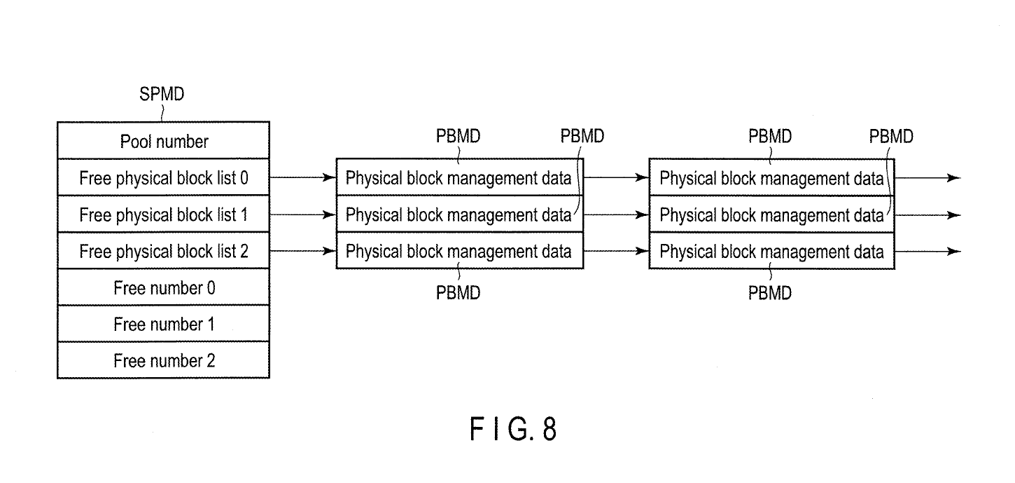

FIG. 8 shows an example of the data structure of the storage pool management data SPMD. As shown in FIG. 8, the storage pool management data SPMD comprises a pool number, a free physical block list*, and a free number* (here, *=0, 1, 2).

The pool number is a number that is allocated to the storage pool (hereinafter, referred to as a corresponding storage pool) managed based on the storage pool management data SPMD. The free physical block list* and the free number* are prepared for each performance attribute described above. In the embodiment, the storage pool management data SPMD includes free physical block lists 0, 1, and 2 and free numbers 0, 1, and 2. The free physical block lists 0, 1, and 2 are lists of the physical block management data PBMD of the free physical blocks that are included in the RAID groups in the corresponding storage pool and that correspond to attribute values 0, 1, and 2 of the performance attributes. In the description presented below, the performance attributes having attribute values of 0, 1, and 2 are referred to as performance attributes (attributes) 0, 1, and 2. The free physical block represents a physical block that is not allocated to the logical disk LD. The free numbers 0, 1, 2 represent the number of free physical blocks represented in the free physical block lists 0, 1, and 2.

The logical disk management unit 202 manages the correspondence between the logical block of the logical disk LD and the physical block of the RAID group RG, using the logical-physical mapping table LPMT in which the logical block management data LBMD and the physical block management data PBMD are stored. For example, the logical block management data LBMD may be managed in a hash table form. However, the logical block management data LBMD does not necessarily need to be managed in the hash table form.

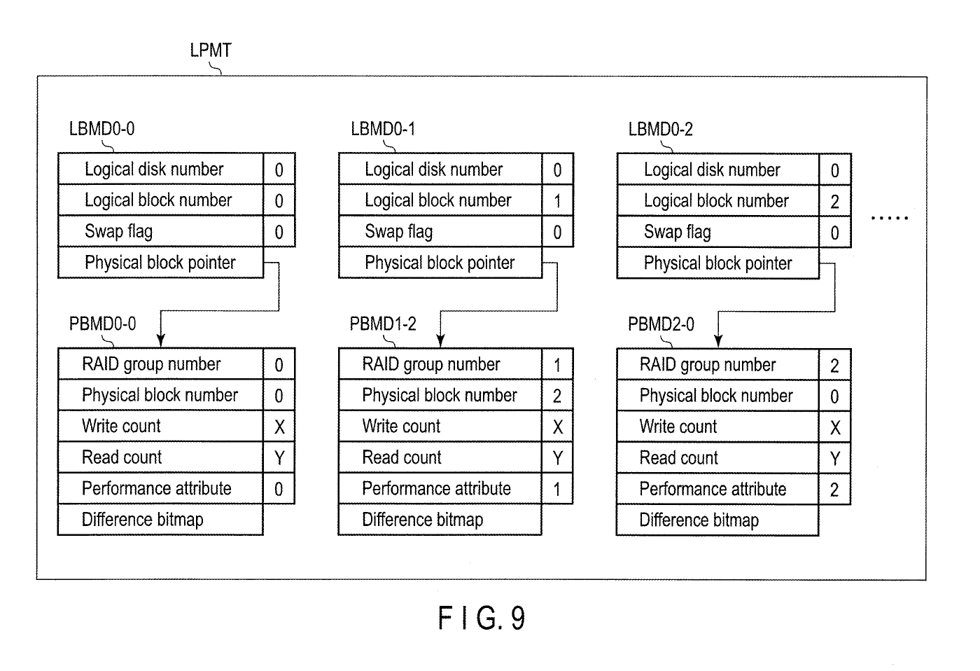

FIG. 9 shows an example of the data structure of the logical-physical mapping table LPMT. In the example shown in FIG. 9, the logical block management data stored in the logical-physical mapping table LPMT includes logical block management data LBMD 0-0, LBMD 0-1, and LBMD 0-2. The logical block management data LBMD x−y (x=0, y=0, 1, 2, . . . ) represents logical block management data used for managing a logical block (that is, the logical block y) having a logical block number of y within the logical disk having a logical disk number of x.

In the example shown in FIG. 9, physical block management data stored in the logical-physical mapping table LPMT includes physical block management data PBMD 0-0, PBMD 1-2, and PBMD 2-0. Physical block management data PBMD p−q (p=0, 1, 2, q=0, 1, 2, . . . ) represents physical block management data used for managing a physical block (physical block q) having a physical block number of q within the RAID group (that is, the RAID group p) having a RAID group number of p. In the example shown in FIG. 9, physical block management data PBMD 0-0, PBMD 1-2, and PBMD 2-0 are indicated by the physical block pointers of the logical block management data LBMD 0-0, LBMD 0-1, and LBMD 0-2.

The replication management unit 203 of the disk array controller 12 manages the replication status using a replication management table (not shown in the figure). The replication is a function for making a copy of a logical disk. Synchronization-split-type replication is applied to the embodiment.

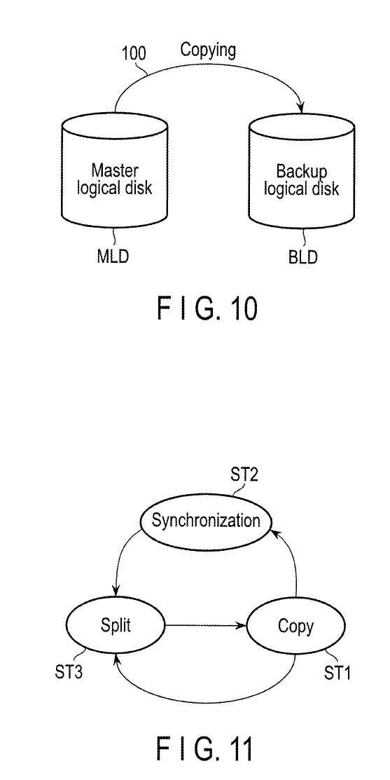

Hereinafter, an overview of the synchronization-split-type replication will be described with reference to FIGS. 10 and 11. FIG. 10 is a diagram illustrating data copy from the master logical disk MLD to the backup logical disk BLD, and FIG. 11 is a diagram illustrating replication status transitions.

First, the replication management unit 203 defines a master logical disk MLD that is a replication source and a backup logical disk BLD that is a replication destination, using the replication management table. In each entry of the replication management table, the logical disk numbers of the master logical disk MLD and the backup logical disk BLD and status information representing a replication status are stored. After the master logical disk MLD and the backup logical disk BLD are defined, the data copy unit 203a of the replication management unit 203 performs data copy as below. In order to shift the replication status of the master logical disk MLD and the backup logical disk BLD to the synchronization status ST2, the data copy unit 203a, as denoted by arrow 100 in FIG. 10, copies data from the master logical disk MLD to the backup logical disk BLD. Here, generally, the relation between the master logical disk MLD and the backup logical disk BLD is referred to as the configuration of replication. Similarly, the relation between physical blocks, which correspond to each other, of the master logical disk MLD and the backup logical disk BLD is referred to as the configuration of replication.

In a case where the master logical disk MLD and the backup logical disk BLD are in the copy status ST1 or the synchronization status ST2, the replication management unit 203 controls the access controller 208 such that the backup logical disk BLD cannot be accessed from the host 20. In addition, when writing data to the master logical disk MLD is requested in the copy status ST1 or the synchronization status ST2, the replication management unit 203 controls the access controller 208 such that data is written to both the master logical disk MLD and the backup logical disk BLD.

After the copying is completed, the replication management unit 203 shifts the replication status from the copy status ST1 to the synchronization status ST2. In the synchronization status ST2, the contents of the master logical disk MLD and the backup logical disk BLD coincide with each other.

In order to allow the backup logical disk BLD to be accessible from the host 20, the replication management unit 203 needs to shift the replication status from the copy status ST1 or the synchronization status ST2 to the split status ST3. In the split status ST3, the master logical disk MLD and the backup logical disk BLD are logically separated from each other and respectively operate as independent logical disks.

The difference management unit 204 of the disk array controller 12 manages the range of writing data for the logical disk MLD in the split status ST3 as a difference (more specifically, the presence of a difference), using the difference bitmap included in corresponding physical block management data PBMD. From this, in a case where data needs to be copied from the master logical disk MLD to the backup logical disk BLD thereafter, the data copy unit 203a may copy only an area in which there is a difference between physical blocks, which correspond to each other, of both disks. By performing the copying of the difference, an unnecessary copy operation can be reduced.

Next, the update (increment) of the read count and the write count used for determining whether to replace physical blocks in the embodiment will be described. When a read request or a write request is received from the host 20, the access controller 208 of the disk array controller 12 specifies logical block management data LBMD used for managing a logical block to be read or to be written as below. Here, the read request or the write request supplied from the host 20 includes a logical disk number designating a logical disk to be accessed, information designating an access range within the logical disk, and a leading logical address LBA in the access range. Here, for simplification of the description, the access range is assumed to be included in a single logical block.

First, the access controller 208 specifies a logical block of the logical disk, which includes the requested access range (logical area), based on the logical disk number and the logical address LBA that is represented by the read request or the write request described above. Next, the access controller 208 refers to the logical block management data LBMD used for managing the specified logical block. Next, the access controller 208 refers to the physical block management data PBMD indicated by the physical block pointer within the logical block management data LBMD that has been referred to.

The access controller 208 determines a disk array and a physical block to which the logical area of the access range requested by the host 20 corresponds, based on the physical block management data PBMD that has been referred to. The access controller 208 performs, based on a result of the determination, a write operation or a read operation that has been requested. At this time, the access controller 208 increments the read count or the write count included in the physical block management data PBMD, which has been referred to, by one. The read count and the write count are statistical values representing the numbers (frequencies) of read accesses and write accesses to corresponding physical blocks.

The physical block replacement determination unit 205, as will be described in detail later, determines whether to replace a target physical block (for example, a physical block of a high load or a low load) based on the read count or the write count of the target physical block. The physical block replacement unit 206 replaces the target physical block with another physical block (for example, a physical block of a higher speed or a lower speed) based on a result of the determination. From this, load distribution that is optimal to the disk array device 10, that is, the optimization of the performance of the disk array device 10 can be achieved.

Next, the hierarchical organization of RAID groups within the storage pool SP will be described. In the embodiment, in order to optimize the performance and the cost, the disk array management unit 201 hierarchically organizes each RAID group (more specifically, the physical areas of the RAID group) within the storage pool SP. Thus, a high-speed/high-cost physical disk group of at least one tier and a low-speed/low-cost physical disk group of at least one tier are connected to the disk interface bus 13 of the disk array device 10. The disk array management unit 201 defines a RAID group (disk array) using a plurality of physical disks of the same tier. The physical block replacement unit 206 determines the tier of the physical block to be allocated to the logical block, based on the performance conditions or the access frequency in cooperation with the physical block replacement determination unit 205.

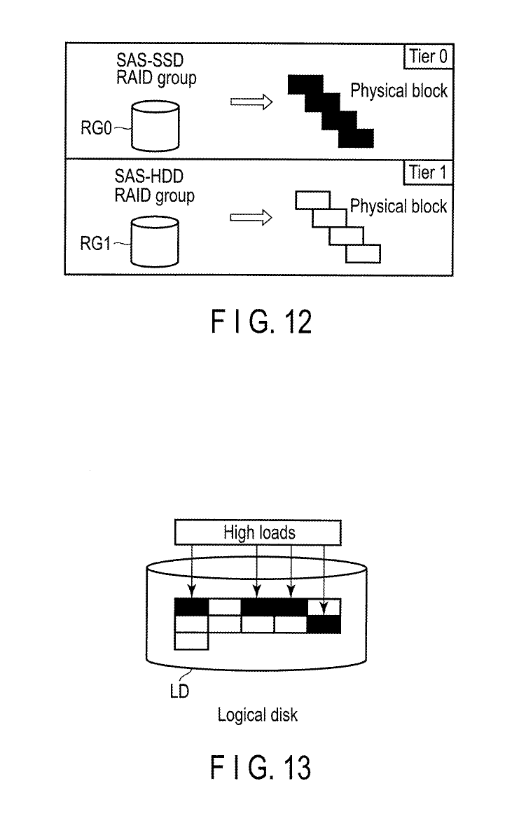

FIG. 12 is a diagram showing an example of the case of two-tier hierarchical organization of physical areas of a RAID group. FIG. 12 shows that RAID groups RG0 and RG1 within the storage pool SP shown in FIG. 4 belong to tiers 0 and 1, respectively. That is, each physical block (a physical block represented by a rectangle filled in black in FIG. 12) within RAID group RG0 belongs to tier 0, and each physical block (a physical block represented by a white rectangle in FIG. 12) within RAID group RG1 belongs to tier 1. In the embodiment, the physical block of tier 0 is a physical block of performance attribute 0, and the physical block of tier 1 is a physical block of performance attribute 1.

RAID group RG0 is a SAS-SSD RAID group that is defined using the SAS-SSD, and RAID group RG1 is a SAS-HDD RAID group that is defined using the SAS-HDD. In FIG. 12, although RAID group RG2 shown in FIG. 4 is not shown, RAID group RG2 is assumed to belong to tier 2. However, in the description presented below, for simplification of the description, it is assumed that there are two RAID groups of RAID groups RG0 and RG1 within the storage pool SP, and the physical areas of the RAID groups are hierarchically organized in two tiers. The physical areas of the RAID groups may be hierarchically organized in three or more tiers. In addition, the disk array management unit 201 may consider the RAID levels applied to the RAID groups (disk arrays) or a difference in the performance due to a difference in the numbers of physical disks configuring the RAID groups in this hierarchical organization.

FIG. 13 illustrates an example of the allocation of physical blocks of different tiers to logical blocks of the logical disk LD. In FIG. 13, each rectangle filled in black inside the logical disk LD represents a logical block to which a physical block of tier 0 is allocated. Many accesses to each logical block represented as the rectangle filled in black are made, and, for example, such a logical block has a high load. Thus, a physical block (that is, the high-speed/high-cost physical block) of tier 0 is allocated to the logical block of a high load, as described above. In addition, in FIG. 13, each white rectangle disposed within the logical disk LD represents a logical block to which a physical block of tier 1 is allocated. The logical block represented by the white rectangle, for example, has a low load. Thus, a physical block (that is, the low-speed/low cost physical block) of tier 1 is allocated to the logical block of a low load as described above.

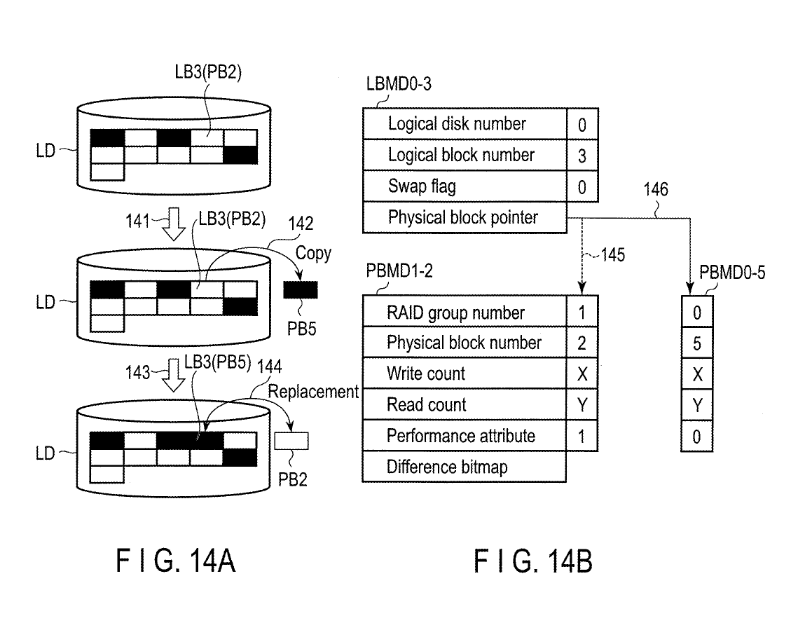

Next, an overview of the process of replacing a physical block allocated to a logical block of the logical disk using tiers will be described with reference to FIGS. 14A and 14B. FIGS. 14A and 14B are diagrams illustrating a physical block replacement process (migration process). FIG. 14A shows an example of a procedure for the physical block replacement process, and FIG. 14B shows an example of the association between the logical block management data and the physical block management data before and after the physical block replacement.

In FIG. 14A, each rectangle, which is filled in black, disposed inside the logical disk LD represents a logical block to which a physical block of tier 0 is allocated. In FIG. 14A, each white rectangle disposed inside the logical disk LD represents a logical block to which a physical block of tier 1 is allocated.

Now, it is assumed that the physical block PB2 of the RAID group RG1 is allocated to the logical block LB3 of the logical disk LD. The logical block LB3 that is in this state is represented by LB3 (PB2) in FIG. 14A. Here, the logical disk number of the logical disk LD is 0, and the logical block number of the logical black LB3 is 3. In addition, the RAID group number of the RAID group RG1 is 1, and the physical block number of the physical block PB2 is 2.

At this time, the physical block pointer within the logical block management data LBMD0-3, which is used for managing the logical block LB3, as denoted by arrow 145 in FIG. 14B, indicates physical block management data PBMD1-2 used for managing the physical block PB2. From this, the association (that is, mapping) between the logical block LB3 and the physical block PB2 is represented. As is apparent from the physical block management data PBMD1-2, the performance attribute of the physical block PB2 is 1, and thus the tier of the physical block PB2, as described above, is 1.

Then, the logical block LB3 is assumed to have a high load. In such a case, since the performance attribute (tier) of the physical block PB2 allocated to the logical block LB3 is 1, the physical block replacement determination unit 205 determines that the physical block PB2 needs to be replaced with a physical block of performance attribute (tier) 0. In addition, this determination, as will be described later in detail, is performed during a replication copy process.

In a case where the physical block needs to be replaced, the physical block selection unit 207 refers to a free physical block list 0 corresponding to the performance attribute (tier) 0 of the storage pool management data SPMD used for managing the storage pool SP. It is assumed that the leading physical block management data PBMD within the free physical block list 0, which has been referred to, is physical block management data PBMD0-5 used for managing the physical block PB5 (5) having a physical block number of 5 within the RAID group RG0 (0) having a RAID group number of 0.

In such a case, the physical block selection unit 207 selects a physical block PB5. Then, the logical disk LD, as denoted by arrow 141 in FIG. 14A, transits to a copy mode (migration copy mode) for replacing a physical block. In this copy mode, the data copy unit 203a copies data of the physical block PB2 currently allocated to the logical block LB3 to a physical block PB5, as denoted by arrow 142 in FIG. 14A.

Then, as denoted by arrow 143 in FIG. 14A, the logical disk LD transits to a physical block replacement mode. In this physical block replacement mode, the physical block replacement unit 206 replaces the physical block PB2 (that is, the physical block PB2 of the RAID group RG1) as the physical block allocated to the logical block LB3, as denoted by arrow 144 in FIG. 14A, with the physical block PB5 (that is, the physical block PB5 of the RAID group RG0). This replacement is implemented by the physical block replacement unit 206 updating the physical block pointer (mapping information) of the logical block management data LBMD0-3, as denoted by arrow 146 in FIG. 14B, so as to indicate the physical block management data PBMD0-5. In addition, the physical block replacement unit 206 registers the physical block PB2 to the end of the free physical block list 1 (that is, the free physical block list 1 corresponding to the performance attribute 1 of the physical block PB2) within the storage pool management data SPMD as a free block. Here, the operation of replacing the physical block PB2 with the physical block PB5 may be performed before the operation of copying data of the physical block PB2 to the physical block PB5.

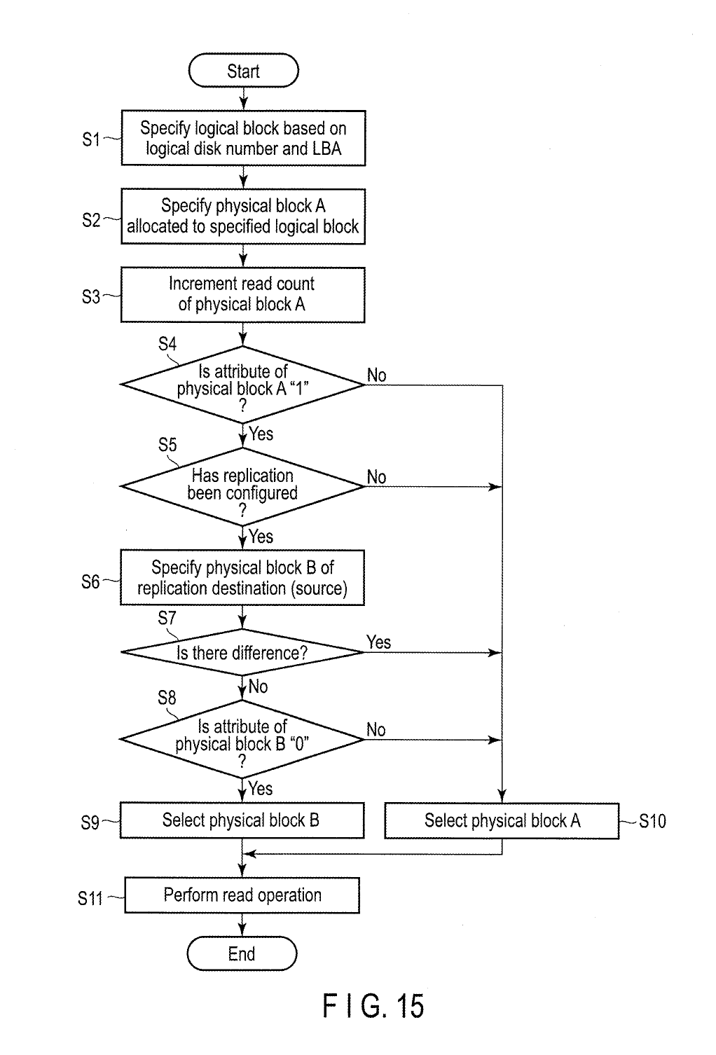

Next, the read process applied to the embodiment will be described with reference to FIG. 15. FIG. 15 is a flowchart showing an exemplary procedure for the read process. Now, it is assumed that the access controller 208 receives a read request from the host 20 via the host I/F 121. Then, the access controller 208 performs the read process as below in accordance with a flowchart shown in FIG. 15. First, the access controller 208, as described above, specifies a logical block of the logical disk that includes the logical area of the requested access range (read range) based on the logical disk number and the logical address LBA represented by the read request (Step S1).

Next, the access controller 208 refers to logical block management data LBMD used for managing the specified logical block. The physical block management data PBMD used for managing the physical block allocated to the specified logical block is indicated by the physical block pointer within the logical block management data LBMD that has been referred to. Accordingly, the access controller 208 specifies a physical block allocated to the specified logical block based on the physical block management data PBMD indicated by the physical block pointer within the block management data LBMD that has been referred to (Step S2). The specified physical block will be represented as physical block A, and the physical block management data PBMD (that is, the physical block management data PBMD used for managing physical block A) used for specifying physical block A will be represented as physical block management data PBMD_A.

Next, the access controller 208 increments the read count (that is, the read count of physical block A) within physical block management data PBMD_A, for example, by one (Step S3). The physical block selection unit 207 determines whether the performance attribute (tier) of physical block A is 1, by referring to the attribute value of the performance attribute of physical block management data PBMD_A (Step S4).

If the performance attribute (tier) of physical block A is 1 (Yes in Step S4), the physical block selection unit 207 determines that physical block A is a low speed (more specifically, low-speed/low-cost) physical block. In such a case, the physical block selection unit 207 determines whether or not physical block A (more specifically, a logical disk including a logical block to which physical block A is allocated) configures a replication with another physical block (Step S5). More specifically, the physical block selection unit 207 determines whether a logical disk (that is, a logical disk having a logical disk number represented by the read request) including the logical block to which physical block A is allocated is defined as a master logical disk or a backup logical disk, by referring to the replication management table.

If physical block A configures the replication (Yes in Step S5), the physical block selection unit 207 specifies a physical block that is a replication destination or a replication source of physical block A (Step S6). When the physical block that is the replication destination or the replication source of physical block A is represented as physical block B, physical block B is specified as below (Step S6).

First, the physical block selection unit 207 specifies the logical disk number of a logical disk that is the replication destination or the replication source of the logical disk having a logical disk number designated by the read request, by referring to the replication management table. Next, the physical block selection unit 207 refers to the logical block management data LBMD including the specified disk number and the logical block number designated by the read request. The physical block management data PBMD indicated by the physical block pointer within the logical block management data LBMDB will be represented as physical block management data PBMD_B. This physical block management data PBMD_B represents physical block B that is the replication destination or the replication source of physical block A.

The physical block selection unit 207 determines whether or not there is a difference between physical blocks A and B by referring to the difference bitmaps within physical block management data PBMD_A and PBMD_B (Step S7). If there is no difference between physical blocks A and B (No in Step S7), the physical block selection unit 207 determines whether the performance attribute (tier) of physical block B is 0, by referring to the attribute value of the performance attribute within physical block management data PBMD_B (Step S8).

If the performance attribute (tier) of physical block B is 0 (Yes in Step S8), the physical block selection unit 207 determines that physical block B is a physical block having a speed higher than physical block A (more specifically, high-speed/high cost). In this case, since there is no difference between physical blocks A and B (No in Step S7), the physical block selection unit 207 selects not physical block A but physical block B having a speed higher than physical block A as the target for a read access (Step S9). That is, the physical block selection unit 207 does not select physical block A specified in Step S2 based on the read request but selects physical block B that has a speed higher than that of physical block A and stores the same data as that of physical block A. In this case, compared to a case where physical block A is selected, a read operation performed at a relatively high speed is expected.

On the other hand, if the performance attribute (tier) of physical block A is not 1 (No in Step S4), that is, if the performance attribute (tier) of physical block A is 0, the physical block selection unit 207 determines that physical block A is a physical block having a high speed (more specifically, high-speed/high-cost). In this case, the physical block selection unit 207 selects physical block A (that is, physical block A specified in Step S2 based on the read request) as the target for a read access (Step S10).

Similarly, also when physical block A does not configure a replication (No in Step S5), the physical block selection unit 207 selects physical block A as the target for a read access (Step S10). Similarly, also when there is a difference between physical blocks A and B (Yes in Step S7), the physical block selection unit 207 selects physical block A as the target for a read access (Step S10). Similarly, also when the performance attribute (tier) of physical block B is not 0 (No in Step S8), that is, also when the performance of physical block B is equal to or less than that of physical block A, the physical block selection unit 207 selects physical block A as the target for a read access (Step S10).

When the physical block selection unit 207 selects physical block A or B in Step S9 or S10, the access controller 208 performs a read operation for reading data from the access range, which is designated by the read request, of the selected physical block (Step S11). Data read by this read operation is returned to the host 20 by the host I/F 121 as a response to the read request from the host 20. The read process described above corresponds to the second data reading described above and is performed when the data of the access range designated by the read request is not stored in the cache memory 123.

According to the embodiment, when a data read from physical block A is requested, and there is physical block B configuring a replication with physical block A, the physical block selection unit 207 selects a physical block from which data is actually to be read based on the presence or absence of a difference between both blocks and the performance attributes of both blocks. More specifically, when there is no difference between physical blocks A and B, that is, when the contents of physical blocks A and B coincide with each other, the physical block selection unit 207 selects one of physical blocks A and B that can be accessed at a high speed as a physical block from which data is to be read. As above, according to the embodiment, the performance of the disk array device 10 is optimized, and accordingly, the disk array device 10 capable of performing a read process at a high speed can be realized.

In the embodiment, by applying a condition that the performance attribute of physical block B is 0 to the determination condition of Step S8, the performance of the disk array device 10 is optimized. However, a technique for optimizing the performance of the disk array device 10 is not limited to that described in the embodiment. That is, a different determination condition may be applied to the process of Step S8. For example, the disk array management unit 201 defines a weight for each performance attribute of the physical block. In such a case, the physical block selection unit 207 may select physical block A or B based on a determination condition that the read counts (or sums of read counts and write counts) of physical blocks A and B, that is, the numbers of inputs/outputs for physical blocks A and B are distributed (load-distributed) at a ratio determined based on the weights (the degree of difference in performance) of physical blocks A and B. According to such load distribution, the performance of the disk array device 10 is optimized, and the disk array device 10 capable of performing a read process at a high speed can be realized.

Next, a write process applied to the embodiment will be briefly described. The write process is mainly different from the read process in the following three points. The first point is that, when physical block A allocated to a logical block designated by the write request is specified, a write count within physical block management data PBMD_A is incremented in a process corresponding to Step S3 shown in FIG. 15. The second point is that, when physical block A configures a replication, in a case where the replication is in the split status, the access range (write range) designated by the write request is recorded in a difference bitmap within physical block management data PBMD_A. The third point is that the write operation is performed in a process corresponding to Step S11 shown in FIG. 15. Except for these three points, the write process is performed similarly to the read process. Thus, a flowchart illustrating the procedure for the write process will not be presented.

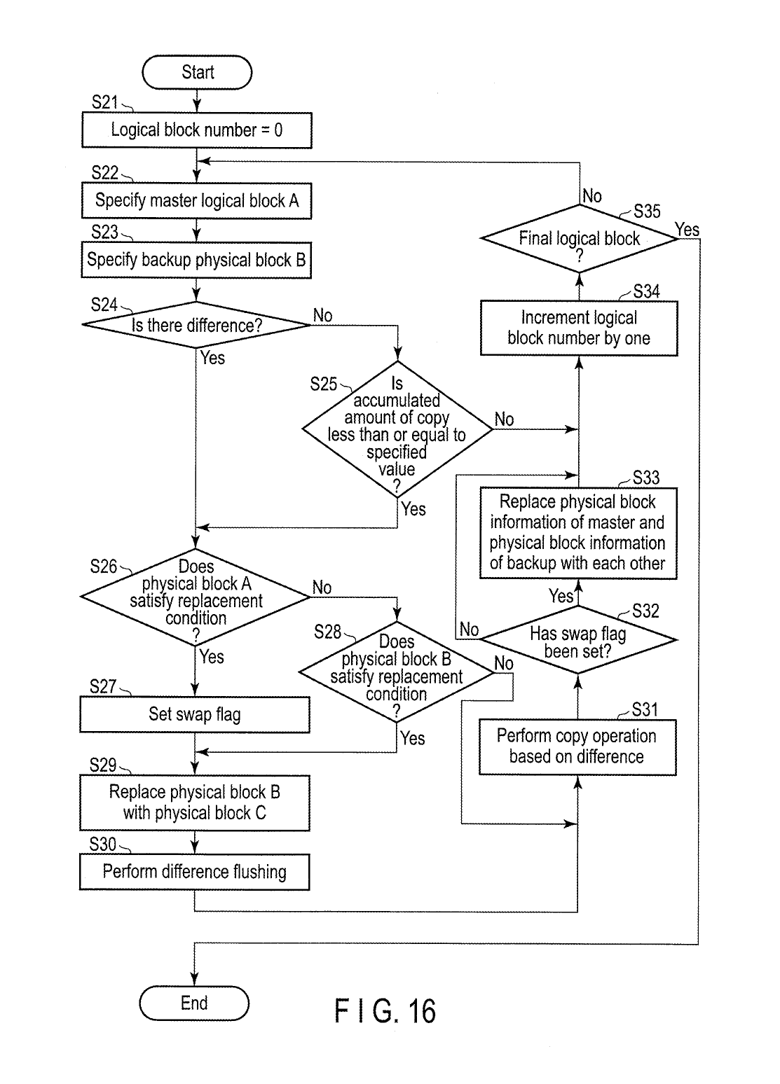

Next, a replication copy process applied to the embodiment will be described with reference to FIG. 16. FIG. 16 is a flowchart showing an exemplary procedure for the replication copy process. Here, it is assumed that a copy operation is performed between the master logical disk MLD and the backup logical disk BLD shown in FIG. 10. In addition, all the logical blocks of the master logical disk MLD and all the logical blocks of the backup logical disk BLD are assumed to be defined using physical blocks of the RAID groups RG0 and RG1 belonging to the storage pool SP.

The replication management unit 203 sets a logical block number representing a logical block of each of the master logical disk MLD and the backup logical disk BLD to zero (Step S21). Here, a logical block of the master logical disk MLD represented by a logical block number (here, 0) that is currently set will be referred to as a target master logical block. Similarly, a logical block of the backup logical disk BLD, which is represented by the logical block number that is currently set, will be referred to as a target backup logical block. In addition, a physical block allocated to the target master logical block will be referred to as master physical block A, and a physical block allocated to the target backup logical block will be referred to as backup physical block B. Furthermore, logical block management data LBMD used for managing the target master logical block will be represented as logical block management data LBMD_M, and logical block management data LBMD used for managing the target backup logical block will be represented as logical block management data LBMD_B.

Next, the replication management unit 203 specifies master physical block A allocated to the target master logical block, using the same method as that of Step S2 in the read process (Step S22). That is, the replication management unit 203 refers to logical block management data LBMD_M. Then, the replication management unit 203 specifies master physical block A based on the physical block management data PBMD indicated by the physical block pointer within logical block management data LBMD_M. The physical block management data PBMD used for specifying master physical block A will be represented as physical block management data PBMD_A.

In addition, the replication management unit 203 specifies backup physical block B allocated to the target backup logical block as below (Step S23). That is, the replication management unit 203 refers to logical block management data LBMD_B. Then, the replication management unit 203 specifies backup physical block B based on the physical block management data PBMD indicated by the physical block pointer within logical block management data LBMD_B. The physical block management data PBMD used for specifying backup physical block B will be represented as physical block management data PBMD_B.

Next, the replication management unit 203 determines whether there is a difference between master physical block A and backup physical block B by referring to the difference bitmap within physical block management data PBMD_A and the difference bitmap within physical block management data PBMD_B (Step S24). If at least one bit of all bits of both difference bitmaps is “1”, the replication management unit 203 determines that there is a difference between master physical block A and backup physical block B. In contrast to this, if all bits of both difference bitmaps are “0”s, the replication management unit 203 determines that there is no difference between master physical block A and backup physical block B.

When there is no difference between master physical block A and backup physical block B (No in Step S24), the replication management unit 203 proceeds to Step S25. In Step S25, the replication management unit 203 determines whether the accumulated amount of the copy in the replication copy process according to the flowchart shown in FIG. 16 is less than or equal to a specified value.

If the accumulated amount of the copy exceeds the specified value (No in Step S25), the replication management unit 203 determines that the load of the replication copy process is high. In this case, the replication management unit 203 proceeds to Step S34 so as to perform the process of a next logical block (a target master logical block and a target backup logical block. A parameter representing the accumulated amount of the copy is stored in a predetermined area of the management data storage unit 209 and is initially set to zero at the time of starting the replication copy process.

In contrast to this, if the accumulated amount of the copy is less than or equal to the specified value (Yes in Step S25), the replication management unit 203 determines that the load of the replication copy process is low. In this case, the replication management unit 203 passes control to the physical block replacement determination unit 205. Also, when there is a difference between master physical block A and backup physical block B (Yes in Step S24), the replication management unit 203 passes the control to the physical block replacement determination unit 205.

Then, the physical block replacement determination unit 205 determines whether or not master physical block A satisfies a predetermined replacement condition based on the performance attribute and read/write count of master physical block A (Step S26). That is, the physical block replacement determination unit 205 determines whether or not the migration of master physical block A is necessary. The read/write count represents one of a read count, a write count, and a sum of the read count and the write count.

In addition, Step S25 is not necessary, and, when there is no difference between master physical block A and backup physical block B (No in Step S24), the replication management unit 203 may proceed to Step S34. In addition, the determination of Step S26 may be performed in a limited manner only when there is a difference between master physical block A and backup physical block B and the amount of the difference exceeds a specified value. Here, when the amount of the difference is less than or equal to the specified value, Step S31 (copy operation) to be described later may be immediately performed.

In the embodiment, the replacement condition is common to master physical block A and backup physical block B and comprises first and second replacement conditions. Here, for the convenience of description, the above-describe replacement condition is assumed to be a replacement condition for master physical block A. The first replacement condition is that the read/write count of master physical block A exceeds a predetermined threshold, and the performance attribute of master physical block A is 1. That is, the first replacement condition is that the load of master physical block A is high, and master physical block A has a low speed. The second replacement condition is that the read/write count of master physical block A is less than or equal to the threshold, and the performance attribute of master physical block A is 0. That is, the second replacement condition is that the load of master physical block A is low, and master physical block A has a high speed.

When master physical block A satisfies the first replacement condition (Yes in Step S26), the physical block replacement determination unit 205 determines that master physical block A needs to be replaced with physical block C that has a performance attribute of 0 and a high speed. In addition, when master physical block A satisfies the second replacement condition (Yes in Step S26), the physical block replacement determination unit 205 determines that master physical block A needs to be replaced with physical block C that has a performance attribute of 1 and a low speed. In each case, physical block C is a physical block having a performance attribute that is different from that of master physical block A. The physical block management data PBMD used for managing this physical block C will be represented as physical block management data PBMD_C.

When master physical block A satisfies the above-described replacement condition (that is, the first or second replacement condition) (Yes in Step S26), the physical block replacement determination unit 205 passes control to the physical block replacement unit 206. Then, the physical block replacement unit 206 sets the swap flag within physical block management data PBMD_A (Step S27), and proceeds to Step S29.

On the other hand, when master physical block A does not satisfy the above-described replacement condition (No in Step S26), the physical block replacement determination unit 205 determines whether or not backup physical block B satisfies the above-described replacement condition (that is, the first or second replacement condition) (Step S28). That is, the physical block replacement determination unit 205 determines whether or not the migration of backup physical block B is necessary, similarly to Step S26. When appropriate, the description of “whether master physical block A satisfies the above-described replacement condition” in Step S26 may be rephrased with master physical block A being replaced with backup physical block B.

When the read/write count of backup physical block B exceeds the threshold, and the performance attribute of backup physical block B is 1 (Yes in Step S28), the physical block replacement determination unit 205 determines that backup physical block B needs to be replaced with physical block C that has a performance attribute of 0 and a high speed. In addition, when the read/write count of backup physical block B is less than the threshold, and the performance attribute of backup physical block B is 0 (Yes in Step S28), the physical block replacement determination unit 205 determines that backup physical block B needs to be replaced with physical block C that has a performance attribute of 1 and a low speed.

When backup physical block B satisfies the above-described replacement condition (that is, the first or second replacement condition) (Yes in Step S28), the physical block replacement determination unit 205 passes control to the physical block replacement unit 206. Then, the physical block replacement unit 206 proceeds to Step S29. In contrast to this, when backup physical block B does not satisfy the replacement condition (No in Step S28), that is, both master physical block A and backup physical block B do not satisfy the replacement condition, the physical block replacement determination unit 205 passes control to the data copy unit 203a. Then, the data copy unit 203a proceeds to Step S31.

In Step S29, the physical block replacement unit 206 replaces backup physical block B with physical block C regardless of the determination made in Step S26 or S28. Physical block C is a physical block having a performance attribute of * (here, * represents 0 or 1), which has been determined in Step S26 by the physical block replacement determination unit 205. The physical block selection unit 207 selects physical block C from the start of the free physical block list*, corresponding to a performance attribute of *, within the storage pool management data SPMD.

The replacement of a physical block in Step S29, as described with reference to FIG. 14B, is performed by updating the physical block pointer. That is, the physical block pointer within the logical block management data LBMD_B, which indicates the physical block B (physical block management data PBMD_B), is updated so as to indicate a physical block C (physical block management data PBMD_C). From this, the backup physical block (that is, a backup physical block that configures a replication with master physical block A) corresponding to master physical block A is switched from the physical block B to the physical block C. At this time, the physical block B (that is, the physical block B that has been used as a backup physical block until the time point of the physical block replacement), similarly to the above-described physical block PB2, is registered in the free physical block list within the storage pool management data SPMD as a free block.

As described above, in the embodiment, also when the result of the determination of Step S26 is “Yes”, the backup physical block B is replaced. The reason for that is as follows. First, in the embodiment, when the result of the determination of Step S26 is “Yes”, the swap flag within physical block management data PBMD_A is set (Step S27). In such a case, in Step S33 to be described later, the physical block pointer within the logical block management data LBMD_M, which indicates the master physical block (=A), is replaced with the physical block pointer within the logical block management data LBMD_B, which indicates the backup physical block. That is, the physical block information (mapping information) is interchanged. At this time, the physical block pointer within the logical block management data LBMD_B has already been updated so as to indicate the physical block C (physical block management data PBMD_C) by performing the process of Step S29. Accordingly, in accordance with the replacement of the physical block pointer (physical block information) in Step S33, the master physical block is substantially switched from physical block A to physical block C. That is, the physical blocks are replaced such that physical block C serves as the master physical block, and the physical block A serves as the backup physical block. In addition, when the result of the determination made in Step S28 is “Yes”, only the backup physical block is switched from physical block B to physical block C.

When the process of Step S29 is performed, in order to copy data of the entire area (all sectors) of the current master logical block A to the backup physical block (that is, the current backup physical block C) in which the replacement is made, using the replication copy operation, the physical block replacement unit 206 performs difference flushing (Step S30). Here, the difference flushing includes setting the entire area (all sectors) of the physical block A to be in the state of having a difference. That is, the difference includes setting all the bits of the difference bitmap (more specifically, a difference bitmap within the physical block management data PBMD_A) of the physical block A to “1”s. When the process of Step S30 is performed, the physical block replacement unit 206 passes control to the data copy unit 203a. Then, the data copy unit 203a proceeds to Step S31.

In Step S31, the data copy unit 203a copies the data of the difference area from the master physical block A to the backup physical block based on both difference bitmaps within the physical block management data PBMD_A and PBMD_B as below. First, the data copy unit 203a merges both difference bitmaps at the time of starting a copy operation. More specifically, the data copy unit 203a merges both the difference bitmaps by calculating the OR of bits, which correspond to each other, of both the difference bitmaps. Areas within the master physical block A (a physical block as a copy source) and the backup physical block (a physical block as a copy destination), which correspond to bits of “1”s within the merged difference bitmap, represent difference areas in which data does not coincide between both blocks. The data copy unit 203a copies data of the difference areas from the master physical block A to the backup physical block based on the differences represented by the bits of “1”s within the merged difference bitmap. At this time, the data copy unit 203a adds the data amount of copy performed in Step S31 to the accumulated amount of the copy at the current time point.

When the process of Step S31 is performed following Step S30, the backup physical block is the physical block C. In addition, all the bits of the difference bitmap (that is, the difference bitmap within the physical block management data PBMDA) of the master physical block A are set to “1”s in Step S30. In this case, the entire areas of the master physical block A and the backup physical block C appear as difference areas. Accordingly, when the process of Step S31 is performed following Step S30, data of the entire area of the master physical block A is copied to the backup physical block C.

In contrast to this, when the process of Step S31 is performed following Step S28, the backup physical block is physical block B. In such a case, data of an areas in which there are differences between master physical block A and physical block B is copied from master physical block A to physical block B.

After the data copy is performed by the data copy unit 203a (Step S31), the physical block replacement unit 206 determines whether or not the swap flag within physical block management data PBMD_A is set (Step S32). If the swap flag is set (Yes in Step S32), the physical block replacement unit 206 proceeds to Step S33.

In Step S33, the physical block replacement unit 206, as described above, replaces the physical block pointer within the logical block management data LBMD_M, which indicates master physical block A, with the physical block pointer within the logical block management data LBMD_B, which indicates the backup physical block (herein the physical block C). By replacing the physical block pointer (that is, the mapping information), the current master physical block A and the backup physical block C are interchanged. That is, the physical blocks can be replaced such that the physical block C serves as the master physical block, and the physical block A serves as the backup physical block.

When the process of Step S33 is performed, the physical block replacement unit 206 passes control to the replication management unit 203. Then, the replication management unit 203 proceeds to Step S34. Meanwhile, if the swap flag has not been set (No in Step S32), the physical block replacement unit 206 skips Step S33 and passes control to the replication management unit 203. Then, the replication management unit 203 proceeds to Step S34.

In Step S34, the replication management unit 203 increments the logical block number by one. Then, the replication management unit 203 determines whether or not the replication copy has been performed up to the final logical block of each of the master logical disk MLD and the backup logical disk BLD based on the logical block number after being incremented by one (Step S35). If the replication copy has not been performed up to the final logical block (No in Step S35), the replication management unit 203 returns to Step S22.

As above, the process starting from Step S22 is repeated for the leading block to the final logical block of each of the master logical disk MLD and the backup logical disk BLD. Then, when the replication copy has been performed up to the final logical block (Yes in Step S35), the replication management unit 203 ends the replication copy process.

In the conventional technology, the data copy (replication copy) between physical blocks accompanying the replication and the data copy (migration copy) between physical blocks accompanying the migration of the physical block are performed independently of each other. However, generally, the data copy between physical blocks in the disk array device 10 affects the performance of a response to the access request from the host device 20.

In contrast to this, in the embodiment, it is determined whether the migration is necessary in units of logical blocks by the physical block replacement determination unit 205 in the replication copy process.

The physical block replacement unit 20 replaces the backup physical block with the physical block C based on the result of the determination. The physical block replacement unit 20 performs the above-described replacement (the operation of replacing the backup physical block with the physical block C) before the data copy (that is, the migration copy) from the master physical block to the backup physical block (that is, the physical block C) which accompanies the replacement, such that the replication copy from the master physical block to the backup physical block, which is performed by the data copy unit 203a, can be used in the data copy. That is, according to the embodiment, the replication copy and the migration copy are simultaneously performed based on the result of the determination. From this, the copy process in the disk array device 10 can be reduced. Therefore, according to the embodiment, a decrease in the performance due to a copy process is reduced, whereby the high-speed disk array device 10 can be realized.

According to at least one embodiment described above, a disk array apparatus, a disk array controller, and a method for copying data between physical blocks, which are capable of reducing the copy operation, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk array apparatus comprising:
a plurality of disk arrays; and
a disk array controller configured to control the plurality of disk arrays,
wherein the disk array controller comprises
a logical block management unit configured to define a plurality of logical disks by allocating a plurality of physical blocks selected from the plurality of disk arrays to the plurality of logical disks;
a data copy unit configured to copy data from a master logical disk to a backup logical disk in order to set the master logical disk and the backup logical disk in a synchronization status; and
a physical block replacement unit configured to allocate a third physical block to the backup logical disk instead of a second physical block that is associated with a first physical block allocated to the master logical disk and is allocated to the backup logical disk, before data is copied from the first physical block to the backup logical disk, when the allocation is changed to the third physical block instead of the second physical block.

2. The disk array apparatus of claim 1, wherein the disk array controller further comprises a physical block replacement determination unit configured to determine whether the allocation is changed to the third physical block instead of the first physical block or the second physical block before the data is copied from the first physical block to the backup logical disk,
wherein the physical block replacement unit is further configured to:
change the allocation to the backup logical disk from the second physical block to the third physical block before the data is copied from the first physical block to the backup logical disk if the replacement of the second physical block is determined; and
change the allocation to the backup logical disk from the second physical block to the third physical block before data is copied from the first physical block to the backup logical disk and change the allocation to the master logical disk from the first physical block to the third physical block after the data is copied from the first physical block to the third physical block if the replacement of the first physical block is determined.

3. The disk array apparatus of claim 2, wherein:
the disk array controller further comprises a difference management unit configured to hold a difference area based on difference information representing a write range for each physical block in accordance with writing data to the physical block;
the data copy unit is configured to copy data from the master logical disk to the backup logical disk based on the difference information; and
the physical block replacement unit is further configured to update the difference information corresponding to the first physical block such that the difference information indicates an entire area of the first physical block as a difference area before data is copied from the first physical block to the backup logical disk if the replacement of the allocation of the first physical block to the master logical disk is determined.

4. The disk array apparatus of claim 3, wherein:
the disk array controller further comprises
an access controller configured to access the logical disk; and
a physical block selection unit configured to select, as a read target physical block, a fifth physical block associated with a fourth physical block allocated to the master logical disk having data to be read if the fifth physical block is present, and no difference between the fourth physical block and the fifth physical block is represented by first difference information corresponding to the fourth physical block and second difference information corresponding to the fifth physical block, wherein an access performance of the fifth physical block is higher than that of the fourth physical block; and
the access controller is further configured to read data from the fifth physical block instead of reading data from the fourth physical block if the fifth physical block is selected.

5. The disk array apparatus of claim 3, wherein:
the disk array controller further comprises
an access controller configured to access the logical disk; and
a physical block selection unit configured to select, as a read target physical block, a fourth physical block allocated to the master logical disk having data to be read or a fifth physical block associated with the fourth physical block such that loads for the fourth physical block and the fifth physical block are distributed at a ratio determined based on weight defined for each performance of the physical blocks if the fifth physical block is present, and no difference between the fourth physical block and the fifth physical block is represented by first difference information corresponding to the fourth physical block and second difference information corresponding to the fifth physical block, wherein an access performance of the fifth physical block is higher than that of the fourth physical block; and
the access controller is further configured to read data from the selected read target physical block.

6. A disk array controller configured to control a plurality of disk arrays, the disk array controller comprising:
a logical block management unit configured to define a plurality of logical disks by allocating a plurality of physical blocks selected from the plurality of disk arrays to the plurality of logical disks;
a data copy unit configured to copy data from a master logical disk to a backup logical disk in order to set the master logical disk and the backup logical disk in a synchronization status; and
a physical block replacement unit configured to allocate a third physical block to the backup logical disk instead of a second physical block that is associated with a first physical block allocated to the master logical disk and is allocated to the backup logical disk, before data is copied from the first physical block to the backup logical disk, when the allocation is changed to the third physical block instead of the second physical block.

7. The disk array controller of claim 6, further comprising a physical block replacement determination unit configured to determine whether the allocation is changed to the third physical block instead of the first physical block or the second physical block before the data is copied from the first physical block to the backup logical disk,
wherein the physical block replacement unit is further configured to:
change the allocation to the backup logical disk from the second physical block to the third physical block before the data is copied from the first physical block to the backup logical disk if the replacement of the second physical block is determined; and
change the allocation to the backup logical disk from the second physical block to the third physical block before data is copied from the first physical block to the backup logical disk and change the allocation to the master logical disk from the first physical block to the third physical block after the data is copied from the first physical block to the third physical block if the replacement of the first physical block is determined.

8. The disk array controller of claim 7, further comprising a difference management unit configured to hold a difference area based on difference information representing a write range for each physical block in accordance with writing data to the physical block,
wherein:
the data copy unit is configured to copy data from the master logical disk to the backup logical disk based on the difference information; and
the physical block replacement unit is further configured to update the difference information corresponding to the first physical block such that the difference information indicates an entire area of the first physical block as a difference area before data is copied from the first physical block to the backup logical disk if the replacement of the allocation of the first physical block to the master logical disk is determined.

9. The disk array controller of claim 8, further comprising:
an access controller configured to access the logical disk; and
a physical block selection unit configured to select, as a read target physical block, a fifth physical block associated with a fourth physical block allocated to the master logical disk having data to be read if the fifth physical block is present, and no difference between the fourth physical block and the fifth physical block is represented by first difference information corresponding to the fourth physical block and second difference information corresponding to the fifth physical block, wherein an access performance of the fifth physical block is higher than that of the fourth physical block,
wherein the access controller is further configured to read data from the fifth physical block instead of reading data from the fourth physical block if the fifth physical block is selected.

10. The disk array controller of claim 8, further comprising:
an access controller configured to access the logical disk; and
a physical block selection unit configured to select, as a read target physical block, a fourth physical block allocated to the master logical disk having data to be read or a fifth physical block associated with the fourth physical block such that loads for the fourth physical block and the fifth physical block are distributed at a ratio determined based on weight defined for each performance of the physical blocks if the fifth physical block is present, and no difference between the fourth physical block and the fifth physical block is represented by first difference information corresponding to the fourth physical block and second difference information corresponding to the fifth physical block, wherein an access performance of the fifth physical block is higher than that of the fourth physical block,
wherein the access controller is further configured to read data from the selected read target physical block.

11. A method, implemented in a disk array controller configured to control a plurality of disk arrays, for copying data between physical blocks, the disk array controller comprising a logical block management unit configured to define a plurality of logical disks by allocating a plurality of physical blocks selected from the plurality of disk arrays to the plurality of logical disks, the method comprising:
copying data from a master logical disk to a backup logical disk in order to set the master logical disk and the backup logical disk in a synchronization status; and
allocating a third physical block to the backup logical disk instead of a second physical block that is associated with a first physical block allocated to the master logical disk and is allocated to the backup logical disk, before data is copied from the first physical block to the backup logical disk, when the allocation is changed to the third physical block instead of the second physical block.

12. The method of claim 11, further comprising:
determining whether the allocation is changed to the third physical block instead of the first physical block or the second physical block before the data is copied from the first physical block to the backup logical disk;
changing the allocation to the backup logical disk from the second physical block to the third physical block before the data is copied from the first physical block to the backup logical disk if the replacement of the second physical block is determined; and
changing the allocation to the backup logical disk from the second physical block to the third physical block before data is copied from the first physical block to the backup logical disk and change the allocation to the master logical disk from the first physical block to the third physical block after the data is copied from the first physical block to the third physical block if the replacement of the first physical block is determined.

13. The method of claim 12, wherein:
the disk array controller further comprises a difference management unit configured to hold a difference area based on difference information representing a write range for each physical block in accordance with writing data to the physical block;
data is copied from the master logical disk to the backup logical disk based on the difference information; and
the method further comprises updating the difference information corresponding to the first physical block such that the difference information indicates an entire area of the first physical block as a difference area before data is copied from the first physical block to the backup logical disk if the replacement of the allocation of the first physical block to the master logical disk is determined.

14. The method of claim 13, further comprising:
selecting, as a read target physical block, fifth physical block associated with a fourth physical block allocated to the master logical disk having data to be read if the fifth physical block is present, and no difference between the fourth physical block and the fifth physical block is represented by first difference information corresponding to the fourth physical block and second difference information corresponding to the fifth physical block, wherein an access performance of the fifth physical block is higher than that of the fourth physical block; and
reading data from the fifth physical block instead of reading data from the fourth physical block.

15. The method of claim 13, further comprising:
selecting, as a read target physical block, a fourth physical block allocated to the master logical disk having data to be read or a fifth physical block associated with the fourth physical block such that loads for the fourth physical block and the fifth physical block are distributed at a ratio determined based on weight defined for each performance of the physical blocks if the fifth physical block is present, and no difference between the fourth physical block and the fifth physical block is represented by first difference information corresponding to the fourth physical block and second difference information corresponding to the fifth physical block, wherein an access performance of the fifth physical block is higher than that of the fourth physical block; and
reading data from the selected read target physical block.
